(19) United States
(12) Patent Application Publication
(10) Pub. No.: US 2009/0210617 A1
(43) Pub. Date: Aug. 20, 2009

(54) MULTI-LEVEL VOLUME TABLE OF CONTENTS

(75) Inventors: Douglas L. Lehr, Tucson, AZ (US); Franklin E. McCune, Tucson, AZ (US); David C. Reed, Tucson, AZ (US); Max D. Smith, Tucson, AZ (US)

Correspondence Address: LAW FIRM OF DAN SHIFRIN, 6208 Devinney Circle, ARVADA, CO, 80004, US

(73) Assignee: IBM CORPORATION, Armonk, NY (US)

(21) Appl. No.: 12/033,383

(22) Filed: Feb. 19, 2008

(51) Int. Cl. G06F 12/00

(52) U.S. Cl. 711/112

(57) ABSTRACT

Methods, data structures and systems provide organize a table of contents for a volume (VTOC) stored in a storage system. The volume is divided into a plurality of ranges of tracks, including a first track range. For each track range, an associated sub-VTOC is created containing information about the contents of the track range. A master VTOC is also created containing a plurality of pointers, each pointer pointing to one of the plurality of sub-VTOCs. A first data set stored on one or more tracks within the first track range is updated and the sub-VTOC associated with the first track range is locked, whereby access to other sub-VTOCs is unaffected. The sub-VTOC associated with the first track range may then be accessed, updated and unlocked. Thus, updating data sets stored within different track ranges on the volume may proceed at the same time.

### TECHNICAL FIELD

The present invention relates generally to data storage systems and, in particular, to the management of information in a volume table of contents.

### BACKGROUND ART

The primary non-volatile storage device used in today's computers is the direct access storage device (DASD), such as magnetic disk storage devices (hard drives), optical data storage disks and other devices that permit the computer to directly access the storage media. Typically, each DASD associated with a computer contains a “volume” of data. Since most large-scale computers generally need more storage space than a single volume can provide, most have access to multiple volumes via multiple DASDs. A volume includes one or more data sets, each of which comprises a collection of related data.

Certain items of information may be associated with each volume. For example, the DASD that contains a volume also contains Volume Table of Contents (VTOC). The VTOC provides a way of locating the data sets that reside on a particular volume and can reside anywhere on the volume it describes. The VTOC lists both the names of the data sets on the volume as well as information such as the size and location of, and permissions related to, each data set. Additionally, the VTOC contains an entry for every block of contiguous free space on the volume. The first record on the first track of the first cylinder of any volume of DASD is known as the volume label and must contain a pointer to the location of the VTOC. A VTOC is added to a disk when it is initialized.

### SUMMARY OF THE INVENTION

The present invention provides a method for organizing a table of contents for a volume (VTOC) stored in a storage system. The method comprises dividing the volume into a plurality of ranges of tracks, including a first track range. For each track range, an associated sub-VTOC is created containing information about the contents of the track range. A master VTOC is also created containing a plurality of pointers, each pointer pointing to one of the plurality of sub-VTOCs. A first data set stored on one or more tracks within the first track range is updated and the sub-VTOC associated with the first track range is locked, whereby access to other sub-VTOCs is unaffected. The sub-VTOC associated with the first track range may then be accessed.

The present invention also provides a multi-level data structure for a volume stored in a storage system. The data structure comprises a plurality of sub-volume table of contents (sub-VTOCs) and a master VTOC comprising a plurality of pointers, each pointer pointing to one of the plurality of sub-VTOCs. Each sub-VTOC is associated with one of a plurality of ranges of tracks on which the volume is stored and contains information about the contents of the associated track range.

The present invention further provides a data storage system comprising a storage controller, at least one storage device, each coupled to the storage controller, a multi-level volume table of contents (VTOC) for a data volume stored on the at least one storage device, and a host coupled to the storage controller. The VTOC comprises a plurality of sub-volume table of contents (sub-VTOCs), each associated with one of a plurality of ranges of tracks on which the volume is stored and a master VTOC comprising a plurality of pointers, each pointer pointing to one of the plurality of sub-VTOCs. Each sub-VTOC contains information about the contents of the associated track range. The host comprises a processor, a memory for storing instructions executable by the processor, and an operating system stored in the memory. The operating system comprises instructions for updating a first data set stored on one or more tracks within the first track range, locking the sub-VTOC associated with the first track range, whereby access to other sub-VTOCs is unaffected, and accessing the sub-VTOC associated with the first track range.

### BRIEF DESCRIPTION OF THE DRAWINGS

FIG. 1 is a block diagram of a computer system in which the present invention may be implemented;

FIG. 2 illustrates a VTOC;

FIG. 3 illustrates one embodiment of a multi-level VTOC of the present invention;

FIG. 4 illustrates another embodiment of a multi-level VTOC of the present invention; and

FIG. 5 is a flow chart of a method of the present invention.

### DETAILED DESCRIPTION OF THE PREFERRED EMBODIMENT

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. A module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and may exist, at least partially, merely as electronic signals on a system or network.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The schematic flow chart diagram that follows is generally indicative of one embodiment of the presented process. Other steps and processes may be conceived that are equivalent in function, logic, or effect to one or more steps, or portions thereof, of the illustrated process. The format and symbols employed are provided to explain the logical steps of the process and are understood not to limit the scope of the process. Additionally, the order in which a particular process occurs may or may not strictly adhere to the order of the corresponding steps shown.

When a computer program needs to locate a data set, it will generally interrogate an operating system catalog to find the volume where the data set resides. Having found the correct volume, the volume table of contents (VTOC) is searched to find out where on the disk the data set is stored. Frequently, a data set in a volume is modified or updated such that the information associated with the data set in the VTOC needs to be updated. While the VTOC is being updated, the operating system locks the VTOC and it may not be updated at the same time by any other application or component for changes to other data sets. When volumes contain only a relatively small number of data sets, the impact of VTOC locking on system performance might have been tolerable. However, as the number of data sets in a volume increases to tens and even hundreds of thousands, locking the VTOC for a single update causes a bottleneck and increased contention for the VTOC, a critical system resource.

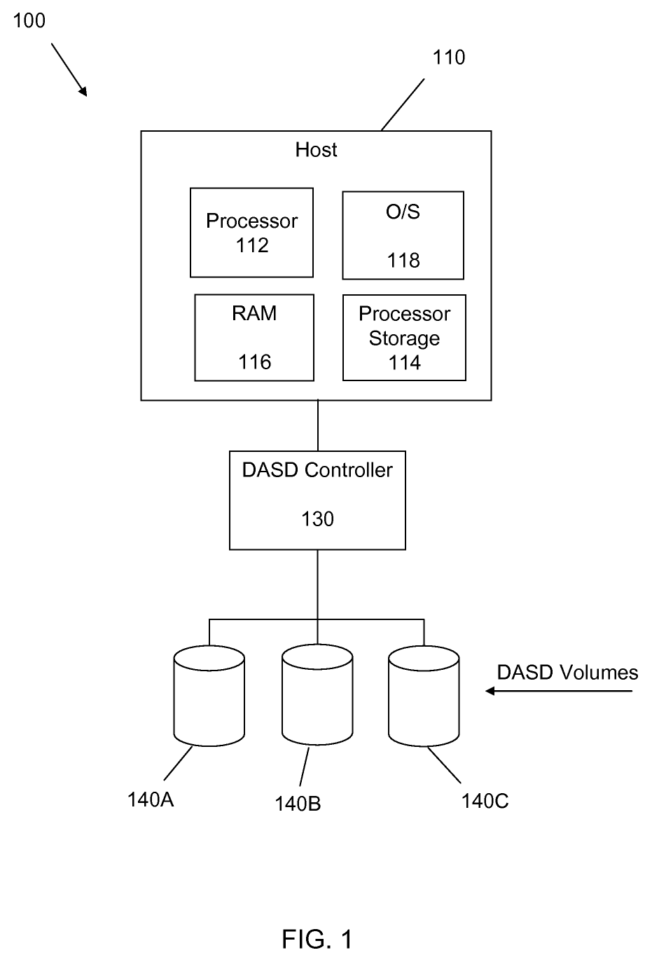

The invention may be implemented in a computer system that includes a central processing unit (CPU) connected to one or more DASDs, which store data pursuant to commands from the CPU. FIG. 1 depicts a computer system 100 for implementing the invention. A host 110 includes a CPU or processor 112, processor storage 114, a RAM memory 116 and an operating system 118. The host 110, for example, may comprise a mainframe computer such as an IBM series z9-109 processor and the operating system 118 may comprise the z/OS operating system. A DASD controller 130 provides an interface between the host 110 and multiple data volumes 140A, 140B, 140C. For purposes of simplicity, only three data volumes are shown in FIG. 1; it will be appreciated that the system 100 may include any number of data volumes. In the illustrated example, each of the volumes 140A, 140B, 140C comprises a different DASD, such as an IBM model DS8100 configured with 3390-9 data storage device. The processor storage 114 may comprise any of a variety of different data storage media, such as DASD, optical media, magnetic tape, electrically programmable memory or the like. In one embodiment, the present invention is implemented by loading a program of instructions from the processor storage 114 to the RAM memory 116, and then operating the processor 112 to execute the instructions stored in the RAM memory 116.

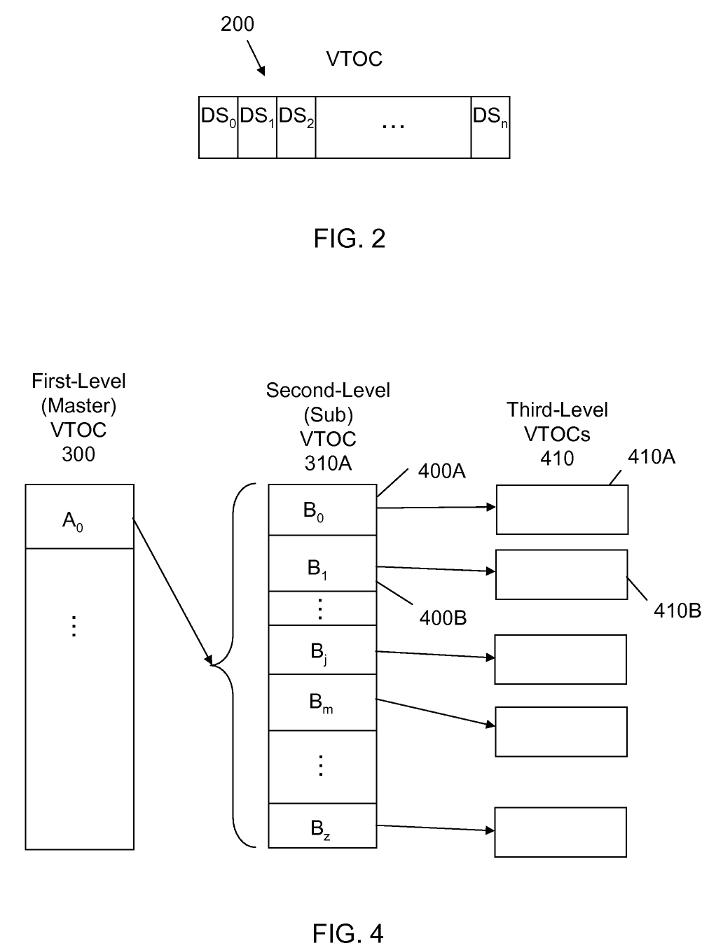

FIG. 2 illustrates a VTOC 200 containing the information needed for the operating system to access the data sets DS0, DS1, DS2, . . . DSn in a particular volume. As previously noted, in a conventional computer system, if a data set, such as DS1, was being updated, the VTOC 200 would be locked while the VTOC was updated. Locking prevents any other data set in the volume from being updated at the same time, thereby imposing a resource bottleneck.

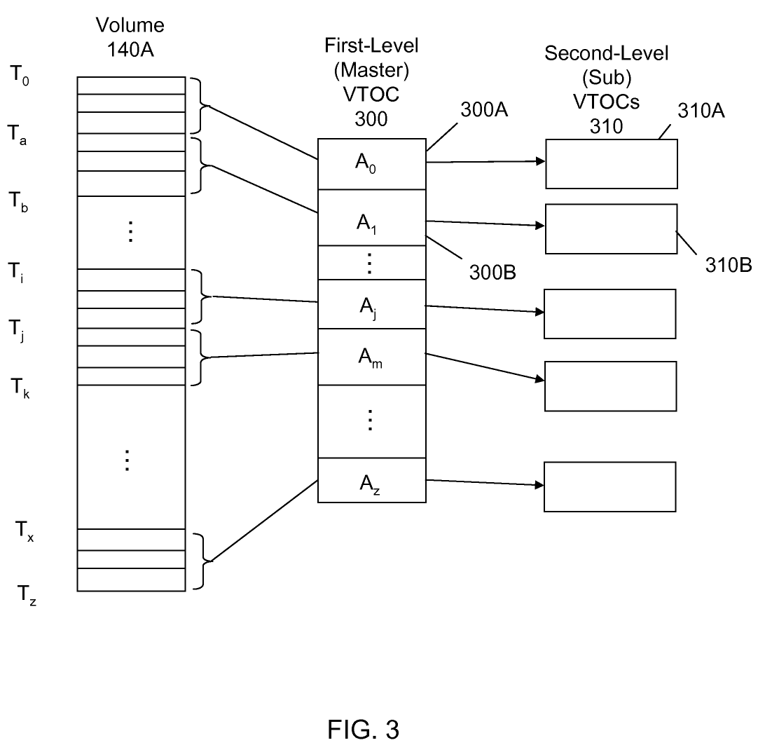

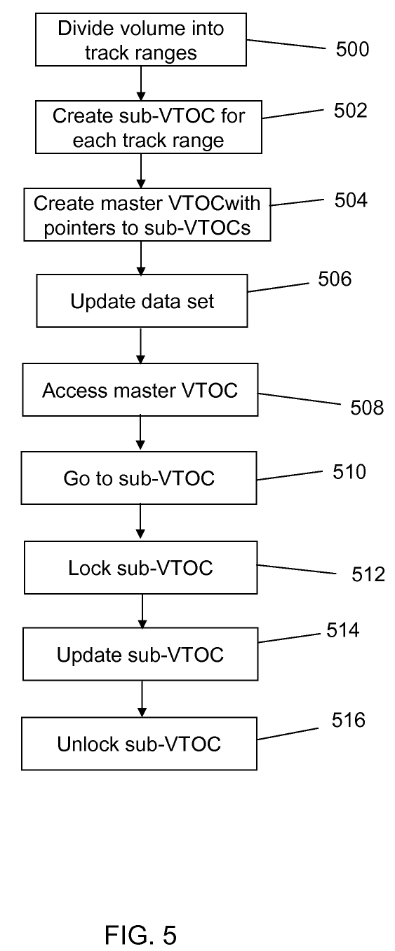

The present invention provides a multi-level VTOC data structure which reduces the bottleneck. As illustrated in FIG. 3, a volume, such as volume 140A, is comprised of numerous tracks T₀-T_{z}. Referring also to the flowchart of FIG. 5, in one embodiment, the volume 140A is divided into track ranges having an equal number of tracks (step 500). Second-level or sub-VTOCs 310 are created (step 502) where the actual table of contents information for each track range is stored. A first-level or master VTOC 300 is created having an entry for each sub-VTOC (step 504). In addition to identifying a particular track range, each entry also includes a pointer to the address for a sub-VTOC 310.

In FIG. 3, the first entry 300A in the master VTOC 300 is associated with tracks T₀-Tₐ and contains a pointer to the address A₀ at which a first second-level or sub-VTOC 310A is located. The first sub-VTOC 310A contains information about any data sets which are stored on the tracks T₀-Tₐ of the volume 140A. Similarly, the second entry 300B in the master VTOC 300 is associated with tracks Tₐ-T_{b} and contains a pointer to the address A₁ at which a second sub-VTOC 310B is located. The second sub-VTOC 310B contains information about any data sets which are stored on the tracks Tₐ-T_{b} of the volume 140A. In order for each sub-VTOC to maintain its identity as a separate and unique resource, each has a different name, such as having a slightly different extension.

In operation, when a data set stored within the track range associated with, for example, the first sub-VTOC 310A is to be modified or updated (step 506), the operating system 118 accesses the master VTOC 300 (step 508). Because a catalog entry exists for all catalog data sets, an additional field may be added to each entry which would include all needed VTOC level entries. The operating system accesses this information to obtain the the tracks on which the data set is located. Knowing the tracks, the operating system 118 reads the address of the sub-VTOC 310A from the appropriate entry in the master VTOC 300. The operating system 118 then accesses (step 510), locks (step (512) and updates the sub-VTOC 310A (step 514). Meanwhile, the other sub-VOTCs remain unlocked and may be locked and updated at the same time by other operations. Once the sub-VTOC 310A has been updated, it is release or unlocked (step 516). Preferably, the only time the master VTOC 300 itself will be locked is when the volume is initialized and the master VTOC 300 established or, subsequently, when pointers are added, deleted or changed, such as when more sub-VTOCs 310 are created.

As illustrated in FIG. 4, the data structure of the present invention may provide additional levels of granularity by subdividing the track ranges associated with one or more second-level (sub-) VTOCs into smaller sub-ranges to be associated with third-level VTOCS. For example, in FIG. 4, the first sub-VTOC 310A is associated with tracks T₀-Tₐ. Rather than the sub-VTOC 310A containing the information needed to access data sets on these tracks, the sub-VTOC 310A contains has entries for sub-ranges of the tracks T₀-Tₐ and pointers associated with the sub-ranges, each of which points to the address of a third-level VTOC, such as 400A, 400B. The third-level VTOC 400A contains information about any data sets which are stored on the tracks T₀-Tₐₐ of the volume 140A while the third-level sub-VTOC 400B contains information about any data sets which are stored on the tracks T_{ab}-T_{bb}. Further levels of sub-VTOCs may be created if desired. Moreover, third-level VTOCs may created for some, but not all, of the track ranges. Because only a third-level VTOC will be locked when a data set is updated, the creation of third- (and beyond) level VTOCs reduces the likelihood of contention for VTOC resources even further than using only sub-VTOCs and allows a greater number of data sets to be updated simultaneously. It will be appreciated that the lettered subscripts associated herein with tracks are merely representative of track numbers and track ranges and are in no way meant to be limiting. For example, an entire volume may have 100,000 tracks. A first sub-VTOC may include the track range of T₀-T_{50,000} while a second sub-VTOC may include the remaining track range T_{50,001}-T_{100,000}. A first second-level VTOC may include the track range of T₀-T_{25,000} and a first third-level VTOC may include the track range of T₀-T_{12,500}.

The volume 140A need not be divided into equal-size track ranges. Instead, the track ranges associated with one or more sub-VTOCs may be customized to accommodate data sets of varying sizes. For example, if a particular data set is very large, a sub-VTOC may be associated with the tracks on which the data set is located. Other sub-VTOCs may be associated with the track on which other data sets are located. Alternatively, the remaining tracks may be divided equally among a number of VTOCs. It will be appreciated that the present invention also contemplates various configurations of second-level VTOCs as well as of third-level VTOCs.

It is important to note that while the present invention has been described in the context of a fully functioning computer system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for organizing a table of contents for a volume (VTOC) stored in a storage system.

What is claimed is:

1. A method for organizing a table of contents for a volume (VTOC) stored in a storage system, comprising:
dividing the volume into a plurality of ranges of tracks, including a first track range;
for each track range, creating an associated sub-VTOC containing information about the contents of the track range;
creating a master VTOC containing a plurality of pointers, each pointer pointing to one of the plurality of sub-VTOCs;
updating a first data set stored on one or more tracks within the first track range;
locking the sub-VTOC associated with the first track range, whereby access to other sub-VTOCs is unaffected; and
accessing the sub-VTOC associated with the first track range.

2. The method of claim 1, further comprising:
when the first data set is updated, accessing the master VTOC to obtain the pointer to a first sub-VTOC; and
using the obtained pointer to access the first sub-VTOC.

3. The method of claim 1, further comprising:
updating a second data set stored on one or more tracks within a second track range;
locking the sub-VTOC associated with the second track range, whereby access to other sub-VTOCs is unaffected; and
accessing the sub-VTOC associated with the second track range simultaneously with accessing the sub-VTOC associated with the first track range.

4. The method of claim 1, further comprising locking the master VTOC only to modify the pointers.

5. The method of claim 1, further comprising:
dividing the first track range into a plurality of sub-ranges of tracks, including a second track range;
for each track sub-range, creating an associated third-level sub-VTOC containing information about the contents of the track sub-range;
populating the sub-VTOC associated with the first track range with a plurality of pointers, each pointer pointing to one of the plurality of third-level sub-VTOCs.
updating a second data set stored on one or more tracks within the second track range;
locking the third-level sub-VTOC associated with the second track range, whereby access to other third-level sub-VTOCs is unaffected; and
accessing the third-level sub-VTOC associated with the second track range.

6. A multi-level data structure for a volume stored in a storage system, comprising:
a plurality of sub-volume table of contents (sub-VTOCs), each associated with one of a plurality of ranges of tracks on which the volume is stored, including a first track range, and each sub-VTOC containing information about the contents of the associated track range; and
a master VTOC comprising a plurality of pointers, each pointer pointing to one of the plurality of sub-VTOCs.

7. The data structure of claim 6, further comprising:
a plurality of third-level sub-VTOCs, each associated with a plurality of sub-ranges of tracks of the first track range and each containing information about the contents of the track sub-range; and
the sub-VTOC associated with the first track range comprising a plurality of pointers, each pointer pointing to one of the plurality of third-level sub-VTOCs.

8. A data storage system, comprising:
a storage controller;
at least one storage device, each coupled to the storage controller;
a multi-level volume table of contents (VTOC) for a data volume stored on the at least one storage device, the VTOC comprising:
a plurality of sub-volume table of contents (sub-VTOCs), each associated with one of a plurality of ranges of tracks on which the volume is stored, including a first track range, and each sub-VTOC containing information about the contents of the associated track range; and
a master VTOC comprising a plurality of pointers, each pointer pointing to one of the plurality of sub-VTOCs; and
a host coupled to the storage controller, the host comprising:
a processor;
a memory for storing instructions executable by the processor; and
an operating system stored in the memory, comprising instructions for:
updating a first data set stored on one or more tracks within the first track range;
locking the sub-VTOC associated with the first track range, whereby access to other sub-VTOCs is unaffected; and
accessing the sub-VTOC associated with the first track range.

9. The data storage system of claim 8, wherein the operating system further comprises instructions for:
when the first data set is updated, accessing the master VTOC to obtain the pointer to the first sub-VTOC; and
using the obtained pointer to access the first sub-VTOC.

10. The data storage system of claim 8, wherein the operating system further comprises instructions for:
updating a second data set stored on one or more tracks within a second track range;
locking the sub-VTOC associated with the second track range, whereby access to other sub-VTOCs is unaffected; and
accessing the sub-VTOC associated with the second track range simultaneously with accessing the sub-VTOC associated with the first track range.

11. The data storage system of claim 8, wherein the operating system further comprises instructions for locking the master VTOC only to modify the pointers.

12. The data storage system of claim 8, the VTOC further comprising:
a plurality of third-level sub-VTOCs, each associated with a plurality of sub-ranges of tracks of the first track range and each containing information about the contents of the track sub-range; and
the sub-VTOC associated with the first track range comprising a plurality of pointers, each pointer pointing to one of the plurality of third-level sub-VTOCs.

13. The data storage system of claim 12, wherein the operating system further comprises instructions for:
updating a second data set stored on one or more tracks within the second track range;
locking the third-level sub-VTOC associated with the second track range, whereby access to other third-level sub-VTOCs is unaffected; and
accessing the third-level sub-VTOC associated with the second track range.

14. A computer program product of a computer readable medium usable with a programmable computer, the computer program product having computer-readable code embodied therein for organizing a table of contents for a volume (VTOC) stored in a storage system, the computer-readable code comprising instructions for:
dividing the volume into a plurality of ranges of tracks, including a first track range;
for each track range, creating an associated sub-VTOC containing information about the contents of the track range;
creating a master VTOC containing a plurality of pointers, each pointer pointing to one of the plurality of sub-VTOCs;
updating a first data set stored on one or more tracks within the first track range;
locking the sub-VTOC associated with the first track range, whereby access to other sub-VTOCs is unaffected; and
accessing the sub-VTOC associated with the first track range.

15. The computer program product of claim 14, the computer-readable code further comprising instructions for:
when the first data set is updated, accessing the master VTOC to obtain the pointer to the first sub-VTOC; and
using the obtained pointer to access the first sub-VTOC.

16. The computer program product of claim 14, the computer-readable code further comprising instructions for:
updating a second data set stored on one or more tracks within a second track range;
locking the sub-VTOC associated with the second track range, whereby access to other sub-VTOCs is unaffected; and
accessing the sub-VTOC associated with the second track range simultaneously with accessing the sub-VTOC associated with the first track range.

17. The computer program product of claim 14, the computer-readable code further comprising instructions for locking the master VTOC only to modify the pointers.

18. The computer program product of claim 14, the computer-readable code further comprising instructions for:
dividing the first track range into a plurality of sub-ranges of tracks, including a second track range;
for each track sub-range, creating an associated third-level sub-VTOC containing information about the contents of the track sub-range;
populating the sub-VTOC associated with the first track range with a plurality of pointers, each pointer pointing to one of the plurality of third-level sub-VTOCs;
updating a second data set stored on one or more tracks within the second track range;
locking the third-level sub-VTOC associated with the second track range, whereby access to other third-level sub-VTOCs is unaffected; and
accessing the third-level sub-VTOC associated with the second track range.
